(19) United States
(12) Patent Application Publication
(10) Pub. No.: US 2017/0090354 A1
(43) Pub. Date: Mar. 30, 2017

(54) DECORATIVE TONER IMAGE FORMING APPARATUS AND DECORATIVE TONER IMAGE FORMING METHOD

(71) Applicants: KABUSHIKI KAISHA TOSHIBA, Tokyo (JP); TOSHIBA TEC KABUSHIKI KAISHA, Tokyo (JP)

(72) Inventor: Noboru Furuyama, Odawara (JP)

(21) Appl. No.: 14/865,321

(22) Filed: Sep. 25, 2015

(51) Int. Cl. G03G 15/16; G03G 15/01

(52) U.S. Cl. CPC G03G 15/1605; G03G 15/0131

(57) ABSTRACT

In accordance with an embodiment, an image forming apparatus comprises a first toner image forming section, a second toner image forming section and a transfer section. The first toner image forming section forms a first toner image with a first toner containing a metallic pigment or a pearlescent pigment. The second toner image forming section forms a second toner image with a second toner which has transparency to e identify of the first toner through the second toner. The transfer section transfers, after transferring the first toner image, the second toner image onto a medium with the second toner image at least partially overlapped on the first toner image.

### FIELD

Embodiments described herein relate generally to an image forming apparatus and an image forming method.

### BACKGROUND

Typically, the pigment used in a toner for an image forming apparatus (hereinafter referred to as “toner”) is yellow, magenta, cyan or black. However, recently, in addition to the pigments of these four colors, a metallic pigment having a metallic luster or a pearlescent pigment is also used in a package, a card or the like that is required in decorativeness. Such a pigment is harder and greater in particle diameter than the pigments of these four colors. For example, the average particle diameter of the particles of a metallic pigment or a pearlescent pigment is generally about 20-200 micrometers, while that of the particles of the pigment of any of these four colors is several micrometers at most. However, if a medium transferred with a toner containing a decorative pigment is pressed by a fixing member, the big hard particles of the pigment will cause damage to the fixing member. Thus, in some cases, the surface of fixing member is roughed, and the service life of the fixing member is shortened.

### DESCRIPTION OF THE DRAWINGS

FIG. 1 is an external view illustrating an example of an image forming apparatus 1 according to an embodiment;

FIG. 2 is a diagram exemplifying the schematic structure of the image forming apparatus 1 according to the embodiment;

FIG. 3 is a diagram illustrating that a transparent toner image 41 and a decorative toner are transferred on a sheet 40 according to the embodiment;

FIG. 4 is a diagram exemplifying the schematic structure of the fixing section 14 of the image forming apparatus 1 according to the embodiment;

FIG. 5 is a functional block diagram illustrating the control section 15 of the image forming apparatus 1 according to the embodiment;

FIG. 6 is a flowchart illustrating the operation of a printing processing of the image forming apparatus 1 according to the embodiment;

FIG. 7 is a schematic diagram illustrating an image forming apparatus adopting a direct transfer system according to an embodiment; and

FIG. 8 is a diagram illustrating that the transparent toner image 41, the decorative toner and a chromatic toner image 43 are transferred on the sheet 40 according to an embodiment.

### DETAILED DESCRIPTION

In accordance with an embodiment, an image forming apparatus comprises a first toner image forming section, a second toner image forming section and a transfer section. The first toner image forming section forms a first toner image with a first toner containing a metallic pigment or a pearlescent pigment. The second toner image forming section forms a second toner image with a second toner which has a transparency to identify the first toner over the second toenr. After transferring the first toner image onto a medium, the transfer section transfers the second toner image with the second toner image at least partially overlapped on the first toner image.

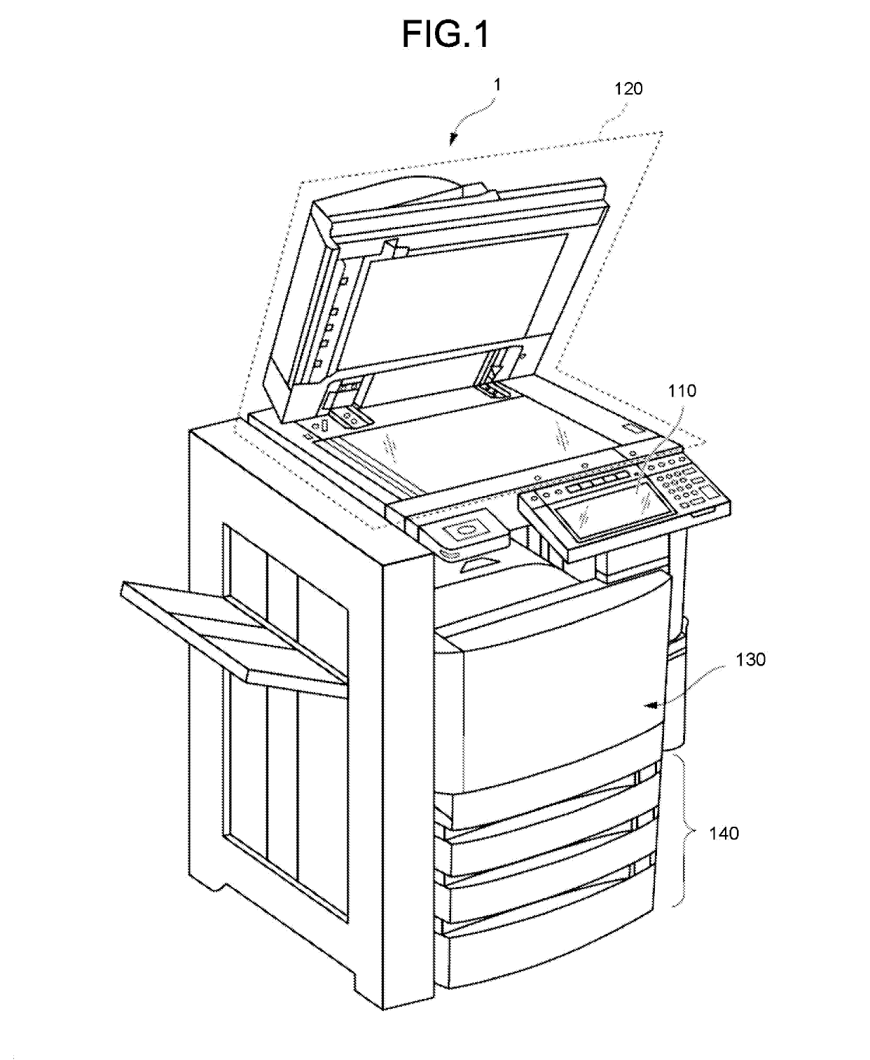

FIG. 1 is an external view illustrating an example of an image forming apparatus 1 according to an embodiment. The image forming apparatus 1 is, for example, an MFP (Multi-Function Peripheral). The image forming apparatus 1 reads the image formed on a sheet-shaped recording medium such as a paper to generate digital data (image file). The image forming apparatus 1 forms an image on a sheet with a toner according to the digital data.

The image forming apparatus 1 comprises a display section 110, an image, reading section 120, an image forming section 130 and a sheet feeding section 140.

The display section 110 functions as an output interface for displaying characters and an image. The display section 110 also functions as an input interface for receiving an instruction from a user. For example, the display section 110 is a liquid crystal display having a touch panel.

The image reading section 120 is a color scanner. The image reading section 120 reads an image formed on a recording medium. The image reading section 120 converts the image read on the medium into digital data. For example, the image reading section 120 comprises a CIS (Contact Image Sensor) or a CCD (Charge Coupled Device). For example, the recording medium is a sheet.

The image forming section 130 forms an image on the medium with a toner. The image forming section 130 forms an image on the recording medium according to the image data read by the image reading section 120 or the image data received from an external device.

The sheet feeding section 140 accommodates the sheet serving as the recording medium. For example, the sheet is an unused sheet or a recycled sheet. The sheet feeding section 140 feeds the recording medium to the image forming section 130.

Next, the toner used by the image forming section 130 in the embodiment is described below. At least two toners, that is, a first toner and a second toner, are used by the image forming section 130 in the embodiment. The first toner is a toner containing a metallic pigment or a pearlescent pigment (hereinafter referred to as ‘decorative toner’).

The decorative toner is a toner which is transferred onto the recording medium to play a decorative function for the surface of the recording medium. For example, the decorative function refers to a function of endowing the image on the sheet with a luster sensation, a glittering sensation or a concave-convex stereoscopic sensation. The pigment used to endow the image on the sheet with such an effect is, for example, a pearlescent pigment or a metallic pigment. For example, the pearlescent pigment or the metallic pigment may be, metal powder such as aluminum powder, brass powder, bronze powder, nickel powder, stainless steel powder and zinc powder. Further, the pearlescent pigment or the metallic pigment may also be mica coated by titanium oxide or yellow iron oxide, barium sulfate, coated sheet-shaped inorganic crystal substrate such as layered silicate or layered aluminum silicate, monocrystal tabular titanium oxide, basic carbonate, acid bismuth oxychloride, natural guanine, sheet-shaped glass powder or metal-deposited sheet-shaped glass powder. Further, when the surface of natural mica (mica) is coated with a metallic oxide having a high refractive index, the multiple reflection resulting from the difference of the refractive indexes of the metallic oxide layer and the natural mica brings a pearly luster like the luster of natural pearl. The pigment is not limited to these mentioned above. 50% of the volume mean particle diameter of the pigment is about 20-100 μm. For example, a pigment having a color developing property is scale-shaped. The decorative toner is a toner mainly formed by covering the pigment with a resin.

The second toner is a highly transparent toner with a transparency that enables the second toner not to affect the identifiability of the first toner.

That is, the second toner, even if overlapped with the first toner by covering the first toner, has a transparency because of which the decorative toner can be fully identified. The transparency refers to the high transmittance of visible lights. For example, the second toner is a transparent toner containing no coloring agent. Further, when the second toner contains a pigment, the average particle diameter of the pigment of the second toner is smaller than that of the pigment of the first toner.

The 50% volume mean particle diameter of the second toner is smaller than particle diameter of the first toner. If the 50% volume mean diameter of the second toner is greater than particle diameter of the first toner, then the second toner is considered to be excessively laminated on the first toner image, and it is therefore considered that the fixation property is deteriorated. The 50% volume, mean particle diameter of the second toner is 1-50 μm, and preferably 1-20 μm.

In the embodiment, the second toner is described as a transparent toner.

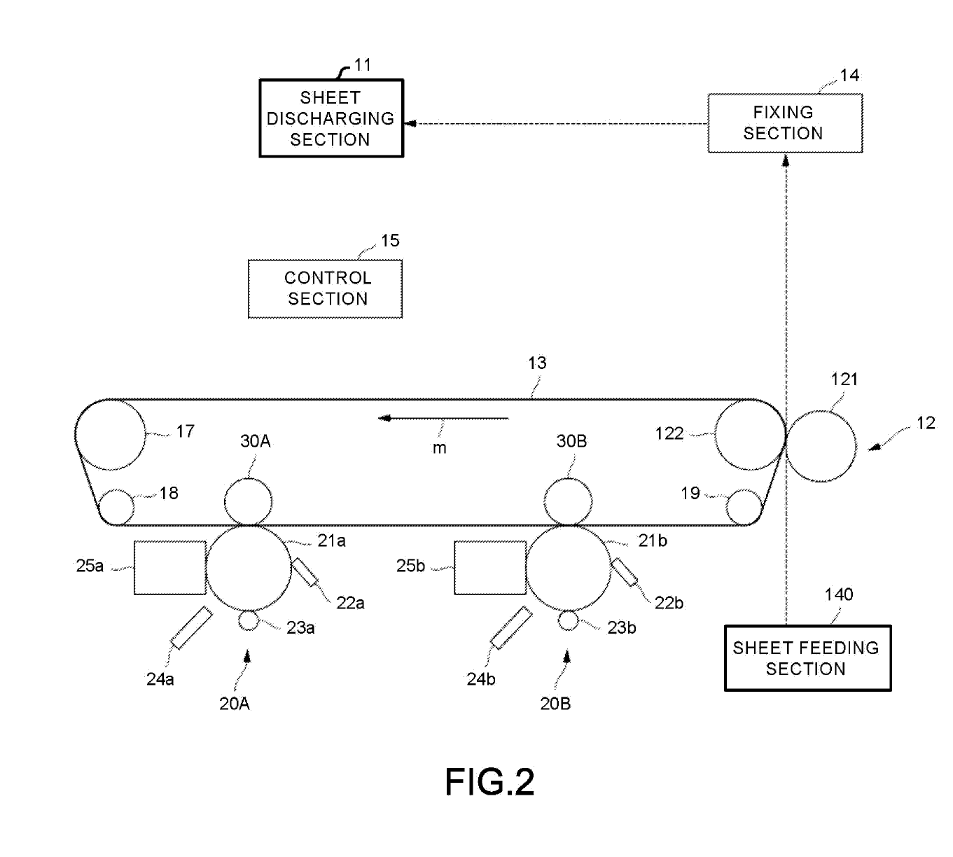

FIG. 2 is a diagram exemplifying the schematic structure of the image forming apparatus 1 according to the embodiment.

The image forming apparatus 1 comprises a sheet discharging section 11, an image forming station 20A (a second toner image forming section), an image forming station 20B (a first toner image forming section), a primary transfer section 30 (primary transfer rollers 30A and 30B), a secondary transfer section 12 (a secondary transfer roller 121 and an opposite roller 122), an intermediate transfer belt 13, a fixing section 14, a control section 15 and a sheet feeding section 140.

The sheet discharging section 11 discharges a sheet 40 on which the fixing section 14 implements a fixation processing to a sheet discharging space (not shown).

The image forming station 20A is located at the upstream side of the image forming station 20B. The image forming station 20A comprises a photoconductor 21a, a photoconductor cleaner 22a, a charger 23a, an exposure device 24a and a developing device 25a. The image forming station 20B comprises a photoconductor 21b, a photoconductor cleaner 22b, a charger 23b, an exposure device 24b and a developing device 25b.

An organic photo conductor (OPC) is arranged on the surfaces of the photoconductors 21a and 21b.

The photoconductor cleaners 22a and 22b remove the residual toner left on the surfaces of the photoconductors 21a and 21b. The residual toner refers to the toner left on the surface of the photoconductor 21a or 21b after a primary transfer.

The chargers 23a and 23b uniformly charge the surfaces of the photoconductors 21a and 21b. For example, the chargers 23a and 23b are scorotron-type corona chargers.

The exposure devices 24a and 24b acquire image data from the control section 15. The exposure devices 24a and 24b irradiate the photoconductors 21a and 21b with laser beams corresponding to the acquired image data. The exposure devices 24a and 24b cause the laser beams to scan the photoconductors 21a and 21b in the axial directions thereof. Electrostatic latent images are formed on the photoconductors 21a and 21b through the scanned exposure of the laser beams.

The developing devices 25a and 25b both comprise a developing roller and a developing motor. Developing agents A and B are accommodated in the developing devices 25a and 25b respectively. The developing agent is the mixer of a toner and a magnetic carrier. The developing agent A accommodated in the developing device 25a is the mixer of a transparent toner and a magnetic carrier. The developing agent B accommodated in the developing device 25b is the mixer of a decorative toner and a magnetic carrier.

The developing device 25a applies a developing bias voltage to the developing roller. The developing agent A is supplied to the photoconductor 21a through the developing bias voltage. Moreover, the electrostatic latent image formed on the photoconductor 21a by the exposure device 24a is formed into a transparent toner image 41.

The developing device 25b applies a developing bias voltage to the developing roller. The developing agent B is supplied to the photoconductor 21b through the developing bias voltage. Moreover, the electrostatic latent image formed on the photoconductor 21b by the exposure device 24b is formed into a decorative toner image 42.

The intermediate transfer belt 13 abuts against the primary transfer rollers 30A and 30B. The intermediate transfer belt 13 is supported by a backup roller 17, a driven roller 18 and a tension roller 19. The intermediate transfer belt 13 rotates in the direction indicated by an arrow m.

The primary transfer rollers 30A and 30B are conductive rollers. The primary transfer roller 30A presses against the photoconductor 21a through the intermediate transfer belt 13. Further, a transfer bias voltage is applied to the primary transfer roller 30A. In this way, the transparent toner image 41 is transferred (primarily transferred) onto the intermediate transfer belt 13.

The primary transfer roller 30B presses against the photoconductor 21b through the intermediate transfer belt 13. Further, a transfer bias voltage is applied to the primary transfer roller 30B. In this way, the decorative toner is transferred (primarily transferred) onto the intermediate transfer belt 13. Herein, the primary transfer rollers 30A and 30B are successively applied with the transfer bias voltage. That is, the intermediate transfer belt 13 transferred with the transparent toner image 41 is conveyed to the transfer area of the image forming station 20B to be transferred with the decorative toner. Consequentially, the decorative toner is primarily transferred onto the all or apart of the transparent toner image 41.

A sheet is fed from the sheet feeding section 140 to the secondary transfer section 12.

The secondary transfer section 12 comprises the secondary transfer roller 121 and the opposite roller 122.

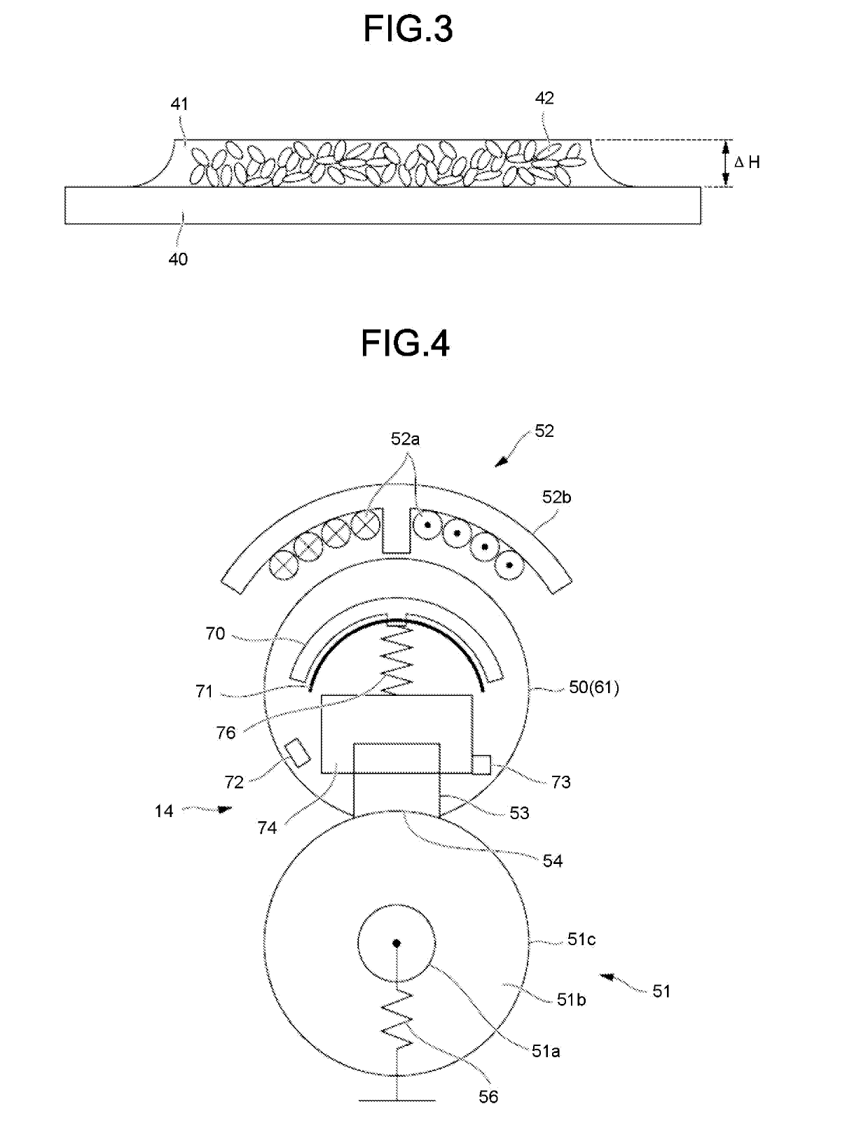

The secondary transfer section 12 is arranged at the downstream side of the image forming station 20B. The secondary transfer roller 121 is arranged opposite to the opposite roller 122 across the intermediate transfer belt 13. The secondary transfer roller 121 is the conductive roller. A given secondary transfer bias voltage is applied to the secondary transfer roller 121. In this way, the secondary transfer roller transfers (secondarily transfers) the decorative toner and the transparent toner image 41 on the intermediate transfer belt 13 onto the sheet fed from the sheet feeding section 140. That is, the image formed by sequentially laminating the transparent toner image 41 and the decorative toner on the intermediate transfer belt 13 is secondarily transferred onto the sheet 40 by the secondary transfer roller 121 and the opposite roller 122. In this manner, an image formed by sequentially laminating the decorative toner and the transparent toner image 41 is formed on the sheet 40. FIG. 3 is a diagram illustrating that the transparent toner image 41 and the decorative toner are transferred on the sheet 40 in the embodiment. As shown in FIG. 3, the secondary transfer section 12 sequentially transfers the decorative toner and the transparent toner image 41 onto the sheet 40 so that the top toner layer is the transparent toner and a decorative toner layer is located below the transparent toner. That is, the transparent toner is laminated by covering a part or all of the decorative toner. As a consequence, when a fixing member pressurizes the sheet 40 during a fixation processing, the area (contact area) where the pigment of the decorative toner abuts against the fixing section 14 is decreased, thus reducing the damage caused by the particles of the decorative toner to the fixing section 14. Further, the layer thickness £H of the transparent toner image 41 that is transferred on the sheet 40 but not fixed may be greater than the 50% volume mean particle diameters of the first toner used in the decorative toner and the pigment contained in the first toner. In this way, the transparent toner is laminated by covering all the decorative toner. Thus, the fixing section 14 and the fixing member do not abut against the pigment used in the decorative toner, thus further reducing the damage caused to the fixing section 14. The layer thickness ΔH can be adjusted by changing the developing bias voltage applied to the developing roller so as to adjust the amount of the second toner affixed to a photoconductive drum.

Moreover, the adhesion between the decorative toner and the sheet 40 can be improved when the transparent toner is laminated by covering a part or all of the decorative toner. The reason is as follows. Generally, the average particle diameter of the pigment of a decorative toner is greater than that of the pigment of a chromatic toner, resulting in a reduced contact area of the pigment of the decorative toner and a medium. The chromatic toner is a cyan, magenta, yellow or black toner. Thus, the adhesion between the decorative toner and the medium is weak. However, in the image forming apparatus 1 of the present embodiment, the transparent toner is adhered with the sheet 40 with the decorative toner sandwiched therebetween. As a consequence, the adhesion between the transparent toner and the sheet is applied to the decorative toner. Further, the decorative toner and the transparent toner are adhered with each other and are therefore integrated. Consequentially, the adhesion area of the toner and the medium is increased, resulting in an improved adhesion between the toner and the sheet. Moreover, the intermediate transfer belt 13 is cleaned by a belt cleaner (not shown) after the secondary transfer is completed.

FIG. 4 is a diagram exemplifying the schematic structure of the fixing section 14 of the image forming apparatus 1 according to the embodiment.

The fixing section 14 heats and pressurizes a sheet transferred with a toner image.

The fixing section 14 comprises a fixing belt 50, a pressure roller 51 and an electromagnetic induction heating coil unit (hereinafter referred to as ‘IH coil unit’) 52.

The fixing belt 50 functions as a heating section. The fixing belt 50 may also be formed into a multi-layer structure having a heating layer 61 serving as a conductive layer. For example, the fixing belt 50 is formed by sequentially laminating the heating layer 61, an elastic layer and a release layer from the internal circumferential side to the external circumferential side of the fixing belt 50. Further, the fixing belt 50, if provided with the heating layer 61, is not limited in layer structure. The heating layer 61 is a layer which emits heat in an induction manner through the magnetic field of the coils of the IH coil unit. For example, the heating layer 61 is made from a conductive material such as iron, nickel or copper. Further, the heating layer 61 may also be formed by laminating a copper layer on a nickel layer. The release layer which is a layer directly contacted with a toner is preferably made from a material with an excellent releasing property. For example, the material with an excellent releasing property is the Teflon.

The fixing belt 50 comprises a pressing pad 53, a magnetic shunt alloy 70, a shield 71, a temperature sensor 72, a thermostat 73 and a frame 74.

The pressing pad 53 is arranged inside the fixing section 14 and located opposite to the pressure roller 51 across the fixing belt 50. The pressing pad 53 supports the internal circumferential surface of the fixing belt 50. For example, the pressing pad 53 is made from heat-resistant polyphenylene sulfide (PPS). Further, a sliding sheet may be arranged between the pressing pad 53 and the fixing belt 50 to reduce the frictional resistance between the fixing belt 50 and the pressing pad 53. For example, the sliding sheet is a component formed by covering the surface of glass fiber with a fluorine resin.

The magnetic property of the magnetic shunt alloy 70 is changed with temperature. The magnetic permeability of the magnetic shunt alloy 70 is reduced when the temperature is above the Curie point temperature. The magnetic flux density passing through the fixing belt 50 is reduced when the magnetic permeability of the magnetic shunt alloy 70 is reduced, resulting in the reduction of the amount of the heat emitted from the fixing belt 50. For example, the magnetic shunt alloy 70 suppresses the temperature increase of the fixing belt 50 in a no-paper passing area. In a low-temperature area where the temperature is below the Curie point temperature, the magnetic shunt alloy 70 assists the fixing belt 50 in heat emission through the heat emission of the magnetic bundles from the IH coil unit 52.

The frame 74 supports the pressing pad 53. The frame 74 supports a supporting spring 76 which adjusts the position of the shield 71 which is, for example, an aluminum component.

The temperature sensor 72 measures the temperature of the fixing belt 50. The temperature sensor 72 can be arranged inside or outside the fixing belt 50. Further, the temperature sensor 72 may be a contact-type sensor which detects the temperature of the fixing belt 50 by contacting the fixing belt 50 or a non-contact-type sensor.

The thermostat 73 detects the abnormal heat emission of the fixing belt 50.

The pressure roller 51 is arranged peripherally opposite to the fixing belt 50.

The pressure roller 51 presses the fixing belt 50 under the spring force of the pressing spring 56, thereby forming a nip 54 between the fixing belt 50 and the pressure roller 51.

The pressure roller 51 comprises a core bar 51a, an elastic layer 51b and a release layer 51c.

The elastic layer 51b is arranged around the core bar 51a. For example, the elastic layer 51b is a heat-resistant rubber layer. The release layer 51c is arranged on the surface of the pressure roller 51. For example, the release layer 51c is made from fluorine resin.

The pressure roller 51 is forced to contact the fixing belt 50 under the pressing force of the pressing spring 56. The fixing section 14 drives the pressure roller 51 so that the fixing belt 50 is driven by the pressure roller 51. Moreover, the fixing belt 50 may also be driven. When the fixing belt 50 and the pressure roller 51 rotate independently, a one-way clutch may be introduced between the fixing belt 50 and the pressure roller 51 to suppress the occurrence of a speed difference therebetween.

The IH coil unit 52 comprises coils 52a and a core 52b. The core 52b covers the periphery of the coils 52a to regulate the magnetic bundles of the coils 52a. That is, the core 52b has a function of shielding the magnetic bundles of the coils 52a. For example, the core 52b is a ferrite core. The IH coil unit 52 generates magnetic bundles in the direction of the fixing belt 50 by applying a high-frequency current to the coils 52a. The heating layer 61 of the fixing belt 50 generates an eddy current and emits heat with the magnetic bundles from the IH coil unit 52.

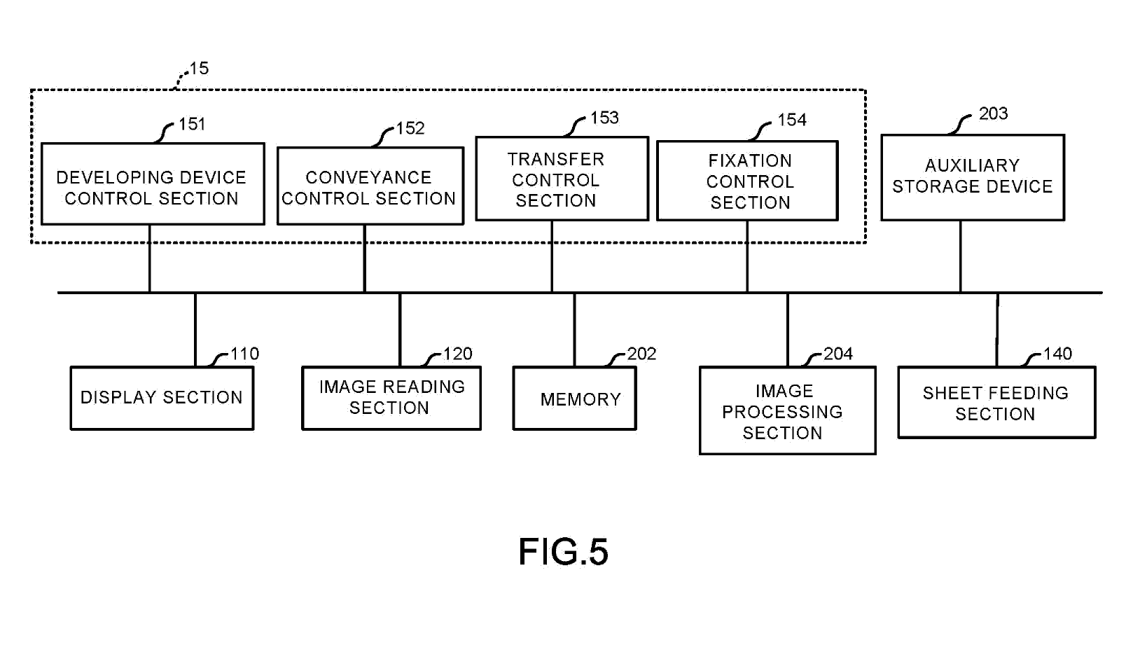

FIG. 5 is a functional block diagram illustrating the control section 15 of the image forming apparatus 1 according to the embodiment.

The image forming apparatus 1 comprises a control section 15, a memory 202, an auxiliary storage device 203, a display section 110, an image reading section 120, a sheet feeding section 140 and an image processing section 204.

The control section 15 executes an image forming program. For example, the image forming program is pre-stored in the auxiliary storage device 203 and read out by the control section 15 from the memory 202. By executing the image forming program, the image forming apparatus 1 implements a printing processing of forming an image on a medium.

The control section 15 comprises a developing device control section 151, a conveyance control section 152, a transfer control section 153 and a fixation control section 154.

The developing device control section 151 controls the developing rollers and the developing motors of the developing devices 25a and 25b. That is, the developing device control section 151 applies a developing bias voltage to the developing rollers. Moreover, the developing device control section 151 drives the developing motors. By controlling the developing rollers and the developing motors, the developing device control section 151 forms a transparent toner image 41 on the photoconductor 21a. By controlling the developing rollers and the developing motors, the developing device control section 151 forms a decorative toner on the photoconductor 21b.

The conveyance control section 152 controls a plurality of conveyance rollers (hereinafter referred to as ‘conveyance mechanism’) such as the intermediate transfer belt 13.

The transfer control section 153 applies a transfer bias voltage to the primary transfer roller 30A.

Further, after applying a transfer bias voltage to the primary transfer roller 30A, the transfer control section 153 applies a transfer bias voltage to the primary transfer roller 30B, thereby laminating the transparent toner image 41 and the decorative toner sequentially on the intermediate transfer belt 13.

The transfer control section 153 applies a secondary transfer bias voltage to the secondary transfer roller 121 so that the toner image (transparent toner image 41 and the decorative toner) laminated on the intermediate transfer belt 13 is secondarily transferred onto the sheet 40.

The fixation control section 154 controls the drive of the fixing section 14. The fixation control section 154 drives the pressure roller 51. Further, the fixation control section 154 acquires the temperature of the fixing belt 50 supplied from the temperature sensor 72. The fixation control section 154 controls the temperature of the fixing belt 50 at a desirable temperature.

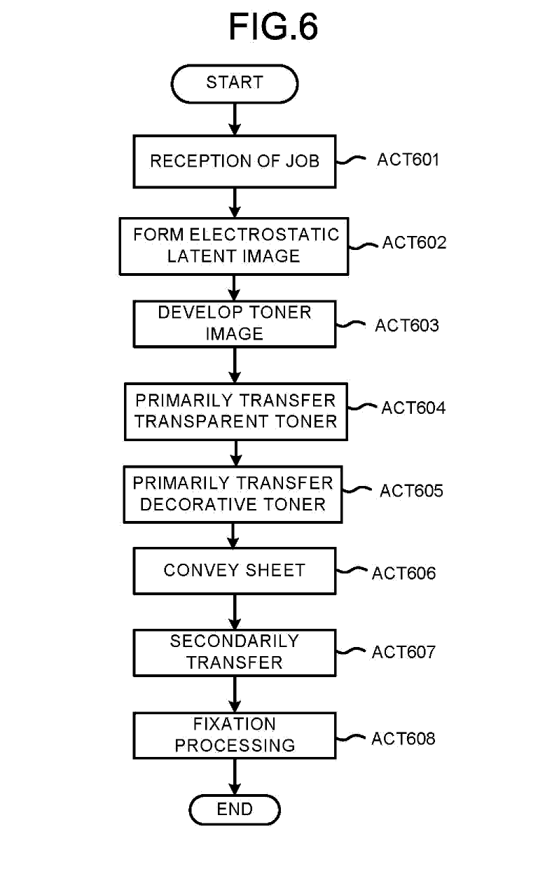

The operations of the printing processing of the image forming apparatus 1 of the present embodiment is described below with reference to accompanying drawings. FIG. 6 is a flowchart illustrating the operations of the printing processing of the image forming apparatus 1 according to the embodiment.

The user inputs, through the display section 110, an instruction for the execution of a printing processing with a decorative toner. The control section 15 manages the processing indicated by the input information by a unit of job. The control section 15 receives the execution of a job according to the input information (Act 601).

The developing device control section 151 drives the developing motors to rotate the photoconductors 21a and 21b. The surface of the photoconductor 21a is uniformly charged by the charger 23a. The surface of the photoconductor 21b is uniformly charged by the charger 23b. Next, the photoconductor 21a is irradiated by the exposure device 24a with laser beams corresponding to image data. Moreover, an electrostatic latent image is formed on the photoconductor 21a. The photoconductor 21b is irradiated by the exposure device 24b with laser beams corresponding to image data. Moreover, an electrostatic latent image is formed on the photoconductor 21b (Act 602).

If the electrostatic latent image is formed, the developing device control section 151 applies a developing bias voltage to the developing roller of the developing device 25a so that the electrostatic latent image of the photoconductor 21a is developed by a transparent toner. Moreover, the transparent toner image 41 composed of the transparent toner is formed on the photoconductor 21a (developing of the toner image). If the electrostatic latent image is formed, the developing device control section 151 applies a developing bias voltage to the developing roller of the developing device 25b so that the electrostatic latent image of the photoconductor 21b is developed by a decorative toner. Moreover, a decorative toner image composed of the decorative toner is formed on the photoconductor 21b (Act 603).

The transfer control section 153 applies a transfer bias voltage to the primary transfer roller 30A. That is, the transfer control section 153 primarily transfers the transparent toner image 41 onto the intermediate transfer belt 13 (Act 604).

The transfer control section 153 applies a transfer bias voltage to the primary transfer roller 30B. That is, the transfer control section 153 primarily transfers the decorative toner onto the intermediate transfer belt 13 (Act 605). In this way, the transfer control section 153 sequentially transfers the transparent toner image 41 and the decorative toner onto the intermediate transfer belt 13 to overlap the decorative toner on the transparent toner image 41.

The conveyance control section 152 conveys a sheet 40 fed from the sheet feeding section 140 to the secondary transfer section 12 in synchronization with the toner image transferred on the intermediate transfer belt 13 (Act 606).

The transfer control section 153 applies a secondary transfer bias voltage to the secondary transfer roller 121 so that the transparent toner image 41 and the decorative toner laminated on the intermediate transfer belt 13 are secondarily transferred onto the sheet 40 (Act 607). In this manner, an image formed by sequentially laminating the decorative toner and the transparent toner image 41 is formed on the sheet 40. That is, the transparent toner is laminated on the sheet 40 by covering a part or all of the decorative toner. If the secondary transfer is completed, the conveyance control section 152 conveys the sheet 40 subjected to the secondary transfer to the nip 54 of the fixing section 14.

The fixation control section 154 drives the pressure roller 51 so that the fixing section 14 melts and fixes the transparent toner image 41 and the decorative toner by endowing the sheet 40 with heat and pressure (Act 608). After the transparent toner image 41 and the decorative toner are fixed, the sheet 40 is discharged to a sheet discharging space (not shown) by the sheet discharging section 11.

In accordance with at least one of the foregoing embodiments, an image forming apparatus 1 includes a decorative toner, a transparent toner and a control section 15. The control section 15 sequentially transfers the decorative toner and the transparent toner onto the sheet 40 serving as a medium with the transparent toner overlapped on the decorative toner. In this way, the transparent toner is laminated by covering the decorative toner, thus, an area where the inside of the nip 54 abuts against the pigment of the decorative toner is decreased during a fixation processing. Consequentially, the image forming apparatus 1 suppresses the damage caused by the pigment of the decorative toner to the inside of the nip 54, thus prolonging the service life of the fixing member.

Further, according to the foregoing embodiment, as the transparent toner is adhered on the sheet 40 by covering the decorative toner, the adhesion between the decorative toner and the sheet 40 is increased.

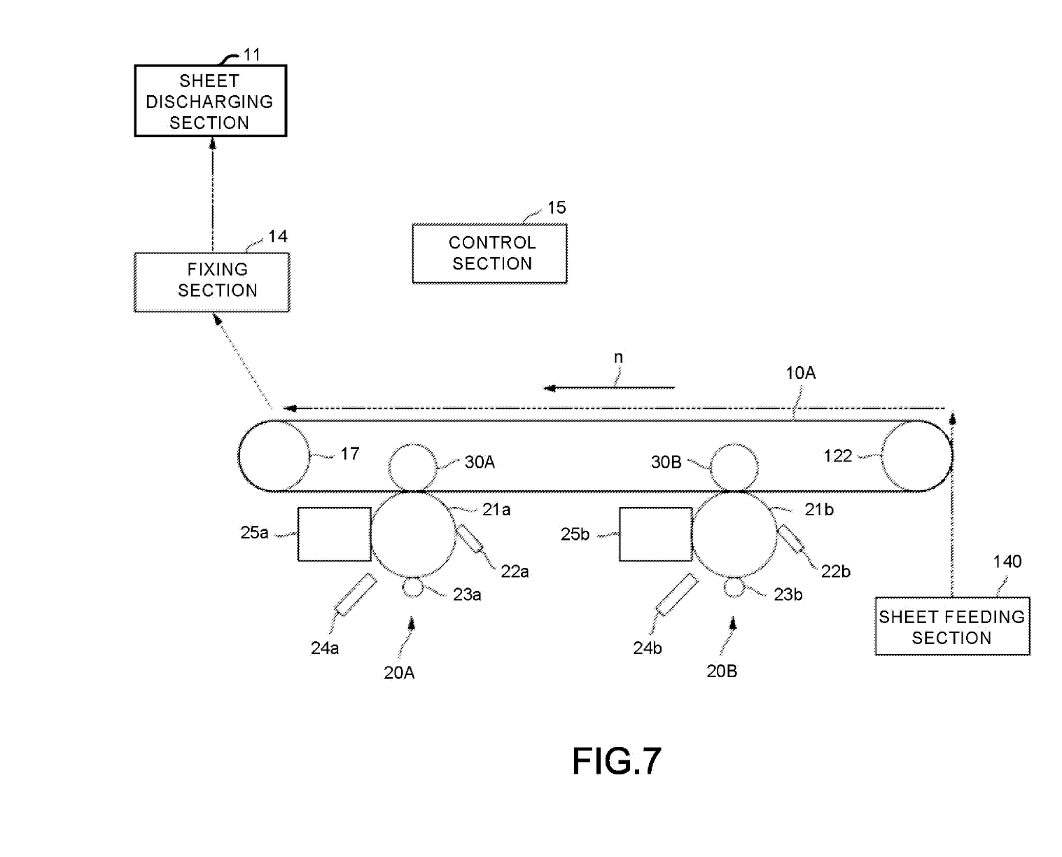

In the foregoing embodiment, the image forming apparatus is an image forming apparatus adopting an intermediate transfer system or a direct transfer system. FIG. 7 is a schematic diagram illustrating an image forming apparatus adopting a direct transfer system. The identical elements shown in FIG. 2 and FIG. 7 are denoted by identical reference signs and are therefore not described in detail repeatedly. The image forming apparatus adopting a direct transfer system comprises a sheet feeding section 140, a fixing section 14, a sheet discharging section 11, an image forming station 20A, an image forming station 20B, a primary transfer roller 30A, a conveyance belt 10A and a control section 15.

The image forming apparatus adopting a direct transfer system directly transfers a toner image formed on a photoconductor onto a medium without using an intermediate transfer belt. That is, the conveyance belt 10A retains a sheet 40 fed from the sheet feeding section 140 on the surface thereof. The conveyance belt 10A conveys the sheet 40 retained on the surface thereof towards the direction indicated by an arrow n. At this time, the primary transfer roller 30B transfers the decorative toner image 42 on the photoconductor 21b onto the sheet 40. Sequentially, the primary transfer roller 30A transfers the toner images on the sheet 40 in such a manner that the transparent toner image on the photoconductor 21a is partially or totally overlapped on the decorative toner image 42. After the transfer, the fixing section 14 carries out a fixation processing for the sheet 40. In this way, even in an image forming apparatus adopting a direct transfer system, a transparent toner can be laminated on the sheet 40 by partially or totally covering a decorative toner. Thus, an area where the inside of the nip 54 abuts against the pigment of the decorative toner is decreased during the fixation processing. In this way, the image forming apparatus adopting the direct transfer system suppresses the damage caused by the pigment of the decorative toner to the inside of the nip 54, thus prolonging the service life of a fixing member.

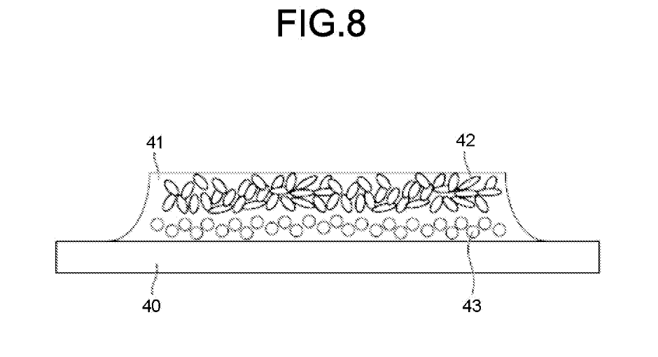

In the foregoing embodiments, the number of the developing devices in the image forming apparatus 1 is not limited. That is, the image forming apparatus 1 is applicable as long as provided with a developing device using a transparent toner and a developing device using a decorative toner. For example, the image forming apparatus 1 may also be equipped with a developing device using at least one of chromatic toners, that is, a cyan toner, a magenta toner, a yellow toner and a black toner. FIG. 8 is a diagram illustrating that the transparent toner image 41, the decorative toner and a chromatic toner image 43 are transferred on the sheet 40 according to the embodiment. In the use of a chromatic toner, toner images are sequentially transferred onto a sheet in sequence of the chromatic toner image 43 formed with the chromatic toner, the decorative toner image 42 and the transparent toner image 41. In this way, the decorative toner image 42 is prevented from losing a color developing property of the toner image by being laminated on the chromatic toner image 43.

In the foregoing embodiment, the image forming section 130 acquires image data from an external device instead of reading image data using the image reading section 120.

Further, the control section 15 records the programs (image forming programs) for totally or partially realizing functions of the control section 15 in a computer-readable recording medium. Moreover, the functions may also be realized through the execution of the programs recorded in the recording medium by a CPU.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

1. An image forming apparatus, comprising:
a first toner image forming section configured to form a first toner image with a decorative toner containing a pigment, the decorative toner having a first 50% volume mean particle diameter;
a second toner image forming section configured to form a second toner image with a transparent toner which covers all the first toner image, the transparent toner having transparency to identify the decorative toner through the transparent toner, the transparent toner having a second 50% volume mean particle diameter that is smaller than the first 50% volume mean particle diameter; and
a transfer section configured to transfer, after transferring the first toner image onto a medium, the second toner image onto the medium with the second toner image at least partially overlapped on the first toner image, wherein the second toner image, which has been transferred on the medium but not fixed, has a layer thickness that is above the average particle diameter of the decorative toner.

2. The image forming apparatus according to claim 1, further comprising:
a primary transfer section configured to transfer toner images in such a manner that the toner image formed with the decorative toner is partially or totally overlapped with the toner image formed on an intermediate transfer belt with the second toner, wherein
the transfer section transfers the toner images transferred on the intermediate transfer belt onto the medium.

3. (canceled)

4. The image forming apparatus according to claim 1, wherein
the first toner image forming section forms the first toner image with the decorative toner containing, as the pigment, a pigment formed by covering fine particles of a metallic oxide with a mica pigment.

5. The image forming apparatus according to claim 1, wherein
the first toner image forming section forms the first toner image with the decorative toner containing, as the pigment, a metallic pigment or a pearlescent pigment.

6. The image forming apparatus according to claim 1, wherein
the transfer section further transfers at least one of chromatic toners, that is, a cyan toner, a magenta toner, a yellow toner and a black toner, onto the medium.

7. The image forming apparatus according to claim 6, wherein
the transfer section transfers the toners onto the medium in such a manner that the chromatic toner, the decorative toner and the transparent toner are sequentially overlapped.

8. The image forming apparatus according to claim 1, wherein
the second toner image forming section forms the second toner image with the transparent toner that is smaller in the average particle diameter than that of the decorative toner.

9. An image forming method, comprising:
forming a first toner image with a decorative toner containing a pigment, the decorative toner having a first 50% volume mean particle diameter;
forming a second toner image with a transparent toner which covers all the first toner image, the transparent toner having a transparency to identify the decorative toner through the transparent toner, the transparent toner having a second 50% volume mean particle diameter that is smaller than the first 50% volume mean particle diameter; and
transferring, after transferring the first toner image onto a medium, the second toner image onto the medium with the second toner image at least partially overlapped on the first toner image, wherein the second toner image, which has been transferred on the medium but not fixed, has a layer thickness that is above the average particle diameter of the decorative toner.

10. The image forming apparatus according to claim 1, further comprising:
a fixing section configured to pressurize a sheet with abutting against the transparent toner covering all the first toner image on the sheet.

11. The image forming apparatus according to claim 10, wherein the fixing section comprises:
a pressure roller;
a fixing belt having a multi-layer structure having a heating layer; and
a pressing pad located opposite to the pressure roller across the fixing belt, the pressing pad supporting an internal circumferential surface of the fixing belt.

12. The image forming apparatus according to claim 11, wherein the fixing belt further comprises a magnetic shunt alloy, a shield, a temperature sensor, a thermostat and a frame.

13. The image forming method according to claim 9, further comprising:
pressurizing, by a fixing member, a sheet with abutting against the transparent toner covering all the first toner image on the sheet.
